(19) United States
(12) Patent Application Publication
(10) Pub. No.: US 2009/0162139 A1
(43) Pub. Date: Jun. 25, 2009

(54) Thermally Insulated Flange Bolts

(75) Inventors: Bradley James Miller, Simpsonville, SC (US); Kenneth D. Black, Travelers Rest, SC (US); Henry Grady Ballard, JR., Easley, SC (US); Rakesh Adoor, Karnataka (IN); Ajay D. Yeole, Nagpur (Maharashtra) (IN)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/959,558

(22) Filed: Dec. 19, 2007

(51) Int. Cl. F16B 13/00

(52) U.S. Cl. 403/296; 29/407.02

(57) ABSTRACT

A turbine/compressor stator joint that may include a flange, an aperture extending through the flange, and a bolt extending through the aperture. The bolt may include a shank and a layer of insulation surrounding the shank.

### TECHNICAL FIELD

The present application relates generally to gas turbines and more particularly relates to the use of insulated bolts between a turbine shell and a compressor discharge casing or between any number of components with a temperature gradient therethrough.

### BACKGROUND OF THE INVENTION

In a conventional gas turbine engine, the turbine shell, the compressor discharge casing, and other elements may be joined by a number of bolts. The bolts, however, may get hot from the hot compressed air in the interior portion of the compressor discharge casing and elsewhere. As the bolts get hotter, the bolts may be subject to creep. The creep may result in a loss of bolt pretension and a reduced lifetime.

Current solutions to preventing creep in high temperature environments include the use of larger bolts or bolts made out of temperature resistant materials such as Inconel (a nickel-chromium alloy). The size of the bolts, however, can only increase so much because of space limitations. Likewise, the use of materials such as Inconel may be much more expensive than bolts made of standard steel or similar materials.

There is thus a desire for a bolted joint connection that reduces the impact of thermal influences but at less expense than with known high heat resistant materials. The bolts preferably will be substantially creep resistant while being reasonably sized and available at a reasonable cost.

### SUMMARY OF THE INVENTION

The present application thus provides for a turbine/compressor stator joint. The turbine/compressor stator joint may include a flange, an aperture extending through the flange, and a bolt extending through the aperture. The bolt may include a shank and a layer of insulation surrounding the shank.

The present application further provides for a method of closing a joint positioned about a hot air pathway. The method may include the steps of covering a bolt shank with a layer of insulation, positioning the bolt shank within an aperture of the joint, positioning a layer of nut insulation about the bolt shank and the joint, and tightening a nut about the bolt shank and the joint.

The present application further provides for a hot air joint. The hot air joint may include a flange, an aperture extending through the flange, and a bolt extending through the aperture. The bolt may be made out of steel. The bolt may include a shank and a layer of shank insulation surrounding the shank.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a cross-section view of a turbine engine showing portions of a combustor, a compressor, and a turbine.

FIG. 2 is a partial side cross-sectional view of a known turbine/compressor shell joint.

FIG. 3 is a partial side cross-sectional view of a turbine/compressor shell joint as is described herein.

FIG. 4 is a partial side cross-sectional view of an alternative embodiment of a turbine/compressor shell joint as is described herein.

FIG. 5 is a partial side cross-sectional view of an alternative embodiment of a turbine/compressor shell joint as is described herein.

### DETAILED DESCRIPTION

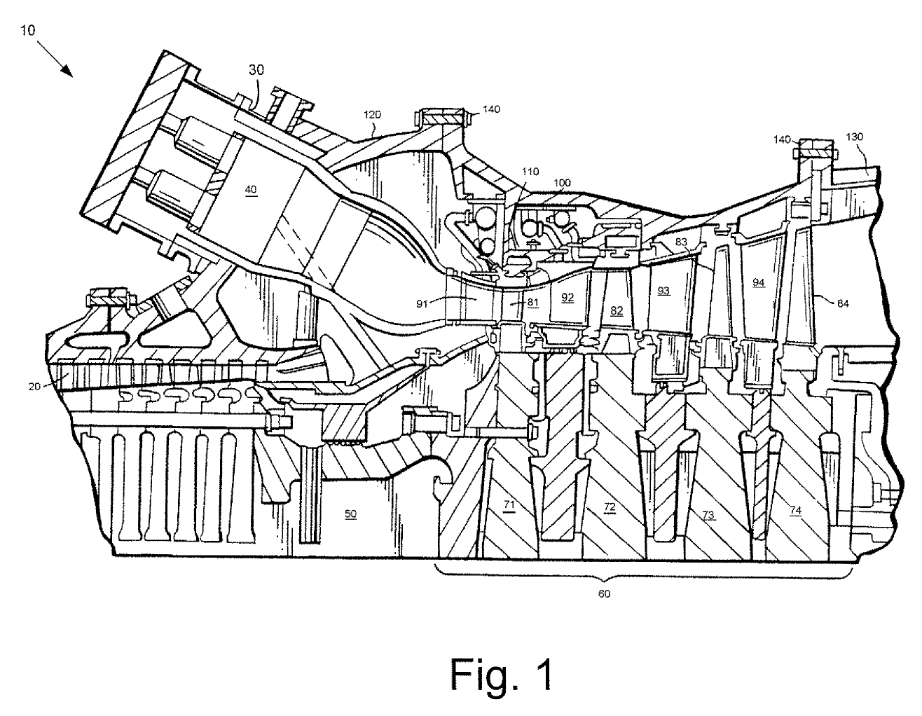

Referring now to the drawings, in which like numerals refer to like elements throughout the several views, FIG. 1 shows a portion of a gas turbine engine 10. As is known, the gas turbine engine 10 includes a compressor 20. The compressor 20 compresses an incoming airflow. The airflow is then discharged to a combustor 30. The combustor 30 includes a number of combustion cans 40. The combustion cans 40 are generally located circumferentially about a rotor shaft 50. The compressed air and a fuel are ignited in the combustion cans 40 and are used to drive a turbine section 60. In the turbine section 60, the energy of the hot gases is converted into mechanical work. Some of the work is used to drive the compressor 20 via the shaft 50 with the remainder being available to drive a load such as a generator.

In this example, the turbine section 60 may have (4) four successive stages represented by four (4) wheels, a first wheel 71, a second wheel 72, a third wheel 73, and a fourth wheel 74. The wheels 71-74 are mounted onto the rotor shaft 50. Each wheel 71-74 carries a row of buckets that include a number of blades, a first blade 81, second blade 82, third blade 83, and the fourth blade 84. The blades 81-84 are arranged alternatively between fixed nozzles that include a number of vanes, a first vane 91, a second vane 92, a third vane 93, and fourth vane 94. Thus, a four staged turbine is illustrated wherein a first stage includes the blade 81 and the vane 91; a second stage includes the blade 82 and the vane 92; a third stage includes the blade 83 and the vane 93; and a fourth stage includes the blade 84 and the vane 94. The turbine section 60, however, may include any number of stages and differing configurations.

The turbine section 60 may include an outer shell 100 and an inner shell 110. The outer shell 100 may be secured at one end to a compressor discharge casing 120 and a turbine exhaust frame 130 at the other. The outer shell 100 may be joined to the compressor discharge casing 120 and to the turbine exhaust frame 130 by a number of bolts 140. The bolts 140 may be of conventional design and materials, oversized, or made of heat resistant materials.

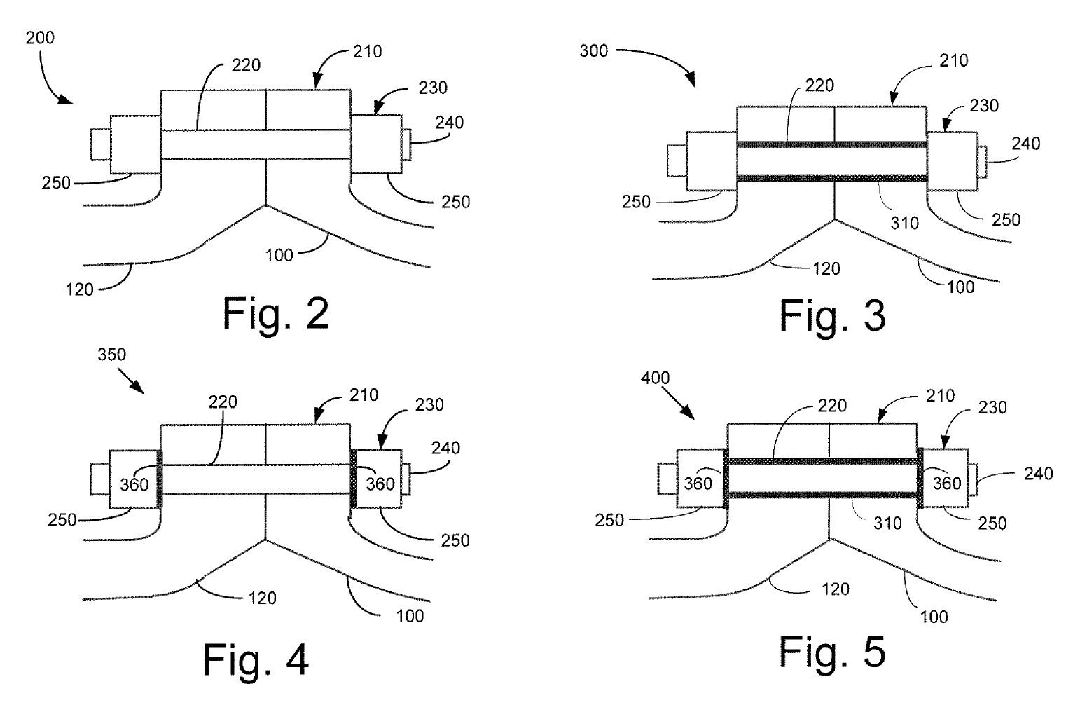

FIG. 2 shows a turbine/compressor shell joint 200 in detail. The turbine/compressor shell joint 200 includes a two-part flange 210. The flange 210 is formed between the compressor discharge casing 120 and the outer turbine shell 100. A flange hole 220 extends through the width of the flange 210. A bolt assembly 230 extends through the flange hole 220 so as to tighten and close the joint 200. The bolt assembly 230 may include a shank 240 that extends through the length of the flange hole 220 and may be closed on either or both ends by a nut 250. The shank 240 and the nuts 250 may be made out of conventional metals including steel-based alloys such as CrMoV, nickel-based alloys such as A286, Inconel 625, Inconel 718, and similar types of materials. The shank 240 may have a diameter between about one (1) to about three (3) inches (about 2.5 to about 7.6 centimeters) and may have a length of about fifteen (15) to about twenty-three (23) inches (about 38 to about 58 centimeters). The nuts 250 may have a thickness of about 1.5 to about three (3) inches (about 3.8 to about 7.6 centimeters) and an outside diameter of about 1.25 to about 3.5 inches (about 3.2 to about 8.9 centimeters). Other dimensions and configurations may be used herein.

Chart I below shows a temperature distribution within the flange 210 and the shank 240 of the bolt assembly 230 under typical operating conditions. As is shown, the temperature of both the flange 210 and the shank 240 initially increases from the compressor discharge casing 120 through the flange 210 and then decreases again towards the outer turbine shell 100.

FIG. 3 shows an improved turbine/compressor shell joint 300 as is described herein. The improved turbine/compressor shell joint 300 may be largely identical to the turbine/compressor shell joint 200 described above but with a layer of shank insulation 310 surrounding the shank 240. The layer of shank insulation 310 may be a layer of a ceramic fiber or wool, a glass fiber or wool, a ceramic foam, an aerogel, or similar types of materials with good insulating properties. The shank insulation 310 may have a thermal conductivity of about 4 e-2 BTU/hr ft ° F. (about 6.9 Watt/meter ° K). The conductivity may range from about 7 e-3 to about 10 e-2 BTU/hr ft ° F. (about 12 e-3 to about 17.3 e-2 Watt/meter ° K). The insulation 310 may have a thickness of about 0.0625 inches (about 1.6 millimeters). Thicknesses in the range of about 0.040 to about 0.125 inches may be used (about 1.02 to about 3.175 millimeters). The thicknesses may vary based upon shell design and other considerations.

Chart II shows the average temperature distribution for the flange 210 and the shank 240. As is shown, the temperature distribution of the shank 240 does not have the peak as is shown in Chart I when the shank insulation 310 is used.

FIG. 4 shows an improved turbine/compressor shell joint 350. The improved turbine/compressor shell joint 350 may be largely identical to the turbine/compressor shell joint 200 but with a layer of nut insulation 360 positioned between each nut 250 and the flange 210. The nut insulation 360 may be in the form of a washer, a layer of insulation similar to the shank insulation 310, or similar configurations. The nut insulation 360 may be made of an alloy that has a thermal conductivity that is less than the bolt and nut material. The nut insulation 360 also may be made from a nickel-based metal, a ceramic, a high temperature steel such as A-286, or similar types of materials with good insulating properties. The material further may vary based upon geometry, operating conditions, and other considerations. The nut insulation 360 may have a thermal conductivity of about 12 BTU/hr ft ° F. (about 20.8 Watt/meter ° K). The conductivity may range from about 8 or less to about 13 BTU/hr ft ° F. (about 13.8 or less to about 22.5 Watt/meter ° K). The insulation 360 may have a thickness of about one (1) inch (about 25 millimeters). Thicknesses in the range of about 0.25 to about two (2) inches (about 6.35 to about 51 millimeters) may be used depending on the conductivity of the washer material.

The nut insulation 360 reduces the heat that can enter the shank 240 from the flange 210 and may dissipate some of the heat from the flange 210 to the air due to the increased surface area. Certain geometries may be cut into the nut insulation 360 so as to increase the heat transfer area to the cooling air about the flange 210. For example, castellation or fins may be used. One can also reduce the heat transfer area between the washer 360 and the flange 210 and/or the washer 360 and the nut 250 or between the nut 250 and the flange 210 by scalloping or castellating the nut contact surface.

Chart III shows the average temperature distribution between the flange 210 and the shank 240. Again, the temperature distribution of the shank 240 is reduced from the baseline case of Chart I although the initial peak shown in Chart I does return.

FIG. 5 shows an improved turbine/compressor shell joint 400 as is described herein. The improved turbine/compressor shell joint 400 may be largely identical to the turbine/compressor shell joint 200 but with the addition of the shank insulation 310 of FIG. 3 and the nut insulation 360 of FIG. 4.

Chart IV below shows the greatest decrease in the temperature of the shank 240. In this case, a temperature difference of about 105° F. (about 40.6° C.) is achieved by use of the shank insulation 310 and the nut insulation 360. Moreover, the temperature within the flange 210 is reduced by about 48.5° F. (about 9.2° C.) as compared to the baseline case of Chart I.

The use of the shank insulation 310 and the nut insulation 360 thus reduces the pathways that allow heat to enter into the bolt assembly 230 by reducing the conductivity along the pathways and also by shielding the pathways. Likewise, the increased surface area that is exposed to the cooling air also may help to remove the heat. As a result, the bolt assembly 230 may be made out of standard materials at a reduced cost but with reduced creep.

Although the invention has been discussed in the context of a turbine/compressor shell joint, the shank insulation 310 and the nut insulation 360 described herein can be used at the turbine shell/turbine exhaust frame joint or at any other desired location within the turbine. This invention also can be used wherever there may be a temperature differential along a bolt relative to a flange. The shank insulation 310 and the nut insulation 360 also may be used wherever a bolt or a similar joinder device is exposed to high temperatures.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

We claim:

1. A turbine/compressor stator joint, comprising:
a flange;
an aperture extending through the flange; and
a bolt extending through the aperture;
the bolt comprising a shank and a layer of shank insulation surrounding the shank.

2. The turbine/compressor stator joint of claim 1, wherein the bolt comprises steel-based alloys or nickel-based alloys.

3. The turbine/compressor stator joint of claim 1, wherein the shank comprises a diameter of about 1 to about 3 inches (about 25 to about 76 millimeters).

4. The turbine/compressor stator joint of claim 1, wherein the layer of shank insulation comprises a ceramic fiber or wool, a glass fiber or wool, a ceramic foam, or a aerogel.

5. The turbine/compressor stator joint of claim 1, wherein the layer of shank insulation comprises a thermal conductivity of about 7 e-3 to about 10 e-2 BTU/hr ft ° F. (about 12 e-3 to about 17.3 e-2 Watt/meter ° K).

6. The turbine/compressor stator joint of claim 1 wherein the layer of shank insulation comprises a thickness of about 0.040 to about 0.125 inches (about 1.02 to about 3.175 millimeters).

7. The turbine/compressor stator joint of claim 1, further comprising a nut positioned about the bolt and wherein the turbine/compressor shell joint further comprises a layer of nut insulation positioned between the nut and the flange.

8. The turbine/compressor stator joint of claim 7, wherein the layer of nut insulation comprises an iron based or nickel based alloy.

9. The turbine/compressor stator joint of claim 7, wherein the layer of nut insulation comprises a thermal conductivity of about 8 or less to about 13 BTU/hr ft ° F. (about 13.8 or less to about 22.5 Watt/meter ° K).

10. The turbine/compressor stator joint of claim 7, wherein the layer of nut insulation comprises a thickness of about 0.25 to about 2 inches (about 6.4 to about 51 millimeters).

11. The turbine/compressor stator joint of claim 7, wherein the layer of nut insulation comprises a washer.

12. A method of closing a joint positioned about a hot air pathway, comprising:
covering a bolt shank with a layer of insulation;
positioning the bolt shank within an aperture of the joint;
positioning a layer of nut insulation about the bolt shank and the joint; and
tightening a nut about the bolt shank and the joint.

13. A hot air joint, comprising:
a flange;
an aperture extending through the flange; and
a bolt extending through the aperture;
the bolt comprising steel; and
the bolt comprising a shank and a layer of shank insulation surrounding the shank.

14. The hot air joint of claim 13, wherein the layer of shank insulation comprises a thermal conductivity of about 7 e-3 to about 10 e-2 BTU/hr ft ° F. (about 12 e-3 to about 17.3 e-2 Watt/meter ° K).

15. The hot air joint of claim 13, wherein the layer of shank insulation comprises a ceramic fiber or wool, a glass fiber or wool, a ceramic foam, or a aerogel.

16. The hot air joint of claim 13, further comprising a nut positioned about the bolt and wherein the joint further comprises a layer of nut insulation positioned between the nut and the joint.

17. The hot air joint of claim 16, wherein the layer of nut insulation comprises a thermal conductivity of about 8 or less to about 13 BTU/hr ft ° F. (about 13.8 or less to about 22.5 Watt/meter ° K).

18. The hot air joint of claim 16, wherein the layer of nut insulation comprises an iron based or nickel based alloy

19. The hot air joint of claim 16, wherein the layer of nut insulation comprises a washer.
